(19) United States
(12) Patent Application Publication
(10) Pub. No.: US 2005/0280392 A1
(43) Pub. Date: Dec. 22, 2005

(54) Fuel cell power adapter for computer system

(76) Inventor: Don J. Nguyen, Portland, OR (US)

Correspondence Address: BUCKLEY, MASCHOFF, TALWALKAR LLC, 5 ELM STREET, NEW CANAAN, CT, 06840, US

(21) Appl. No.: 10/873,571

(22) Filed: Jun. 22, 2004

(51) Int. Cl. H01M 10/44

(52) U.S. Cl. 320/101

(57) ABSTRACT

A system may include a fuel cell system to transmit first data, to generate power, and to deliver the generated power, and a mobile computing system to receive the first data, and to receive the generated power.

### BACKGROUND

The usefulness of a mobile computing system often depends on how long the system can operate without being connected to a stationary power source, such as an AC outlet. Designers of mobile computing systems attempt to extend the length of this period by optimizing the power consumption of such systems. Since such mobile operation requires an attached, mobile power source, the period may also be lengthened by improving conventional or developing new mobile power sources.

Fuel cells have been proposed as one promising mobile power source. More particularly, a system consisting of one or more fuel cells, fuel, control elements and processing/delivery elements might provide mobile and renewable power to a mobile computing system. However, conventional mobile computing systems and fuel cell systems are not equipped for efficient interoperation.

### BRIEF DESCRIPTION OF THE DRAWINGS

FIG. 1 is a block diagram of a system according to some embodiments.

FIG. 2 is a block diagram of a fuel cell system according to some embodiments.

FIG. 3 is diagram of a process according to some embodiments.

FIG. 4 is a schematic and block diagram of a battery pack according to some embodiments.

FIG. 5 is a block diagram of a system according to some embodiments.

FIG. 6 is a schematic and block diagram of a battery pack according to some embodiments.

### DETAILED DESCRIPTION

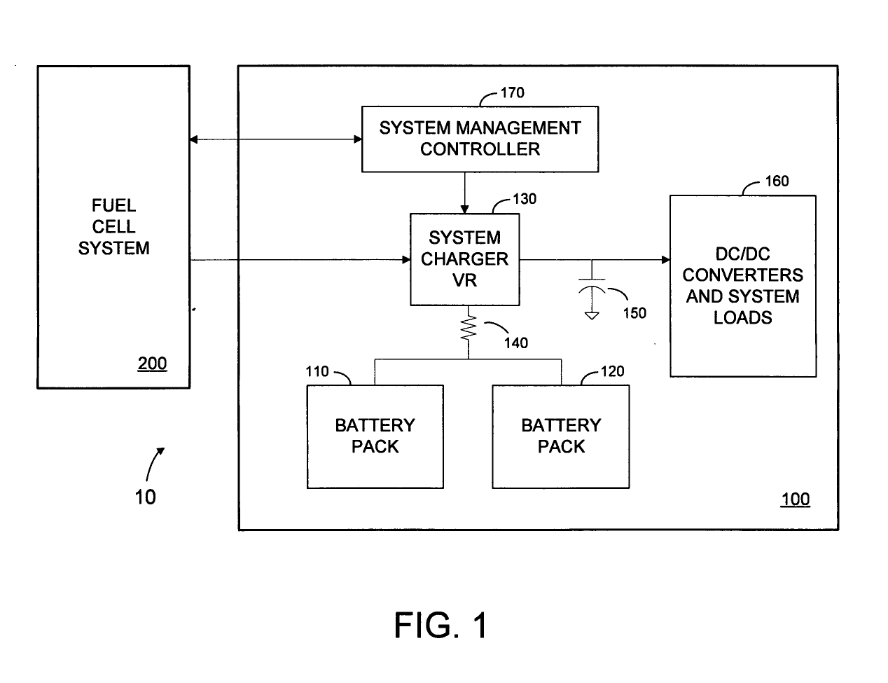

FIG. 1 is a block diagram of system 10 according to some embodiments. System 10 comprises mobile computing system 100 and fuel cell system 200. Mobile computing system 100 may comprise a notebook computer, a telephone, a personal digital assistant, a digital camera, a tablet PC, any system including electrical hardware and requiring a power source, and a system including any combination of the foregoing. Some embodiments will be described below in the context of a notebook computer.

Mobile computing system 100 is configured to consume power provided by battery pack 110 and battery pack 120. Battery pack 110 and battery pack 120 may be charged using system charger voltage regulator (VR) 130 and current sense resistor 140, and the battery power may be delivered using system charger VR 130 and decoupling capacitor 150. Some embodiments include only one or more than two battery packs. As shown, the battery power is provided to and consumed by DC/DC converters and system loads 160, which may include the primary functional elements (e.g., processor, hard drives, memory circuits) of mobile computing system 100. Elements 110 through 160 are arranged pursuant to the September 2003 Narrow VDC Extended Battery Life (EBL) Technique presentation by Intel Corporation©. Other arrangements may be employed in some embodiments.

System charger VR 130 may convert power that is received from fuel cell system 200 at a first voltage (and/or current) level to a second voltage (and/or current) level. According to some examples, fuel cell system 200 generates the power using a stack of three series-connected Li-Ion fuel cells, and the power is converted and output by system charger VR 130 at 8.7 to 12.6V. DC/DC converters 160 may then convert the power to different voltage levels suitable for use by various system loads 160 (e.g., 5V, 3.3V, 1V).

System charger VR 130 may also operate to selectively charge battery packs 110 and 120. Battery packs 110 and 120 may comprise one or more of any currently- or hereafter-known rechargeable battery types suitable for use with mobile computing system 100. These battery types may include, but are not limited to, Li-Ion, NiMH, Zn/Air, Li-Polymer, and Ag/ZN battery types. One or both of battery packs 110 and 120 may be mounted in a device-bay slot, a dedicated battery pack slot, and/or an external pack of mobile computing system 100. Resistor 140 may be used in this regard as a current-sensing resistor to detect and control the voltage and current levels of charging power supplied to battery packs 110 and 120.

Mobile computing system 100 further comprises system management controller 170. In some embodiments, system management controller 170 provides low-level control over some aspects of system 100. Such control may comprise input device control and control over a power consumption mode of system 100. System management controller 170 may communicate with and/or control system charger VR 130, battery packs 110 and 120, and DC/DC converters and system loads 160 via a system management bus (SMBus) in accordance with System Management Bus (SMBus) Specification, ver. 2.0, Aug. 3, 2000, © 2000 SBS Implementers Forum. Implementation details of system charger VR 130 and battery packs 110 and 120 having such functionality are known to those in the art and are included in the NVDC EBL specification.

System management controller 170 may receive data from fuel cell system 200. System management controller 170 may also or alternatively transmit data to fuel cell system 200 in some embodiments. As illustrated in FIG. 1, this data may be received and transmitted independently from the power received by system charger VR 130. For example, system 100 may comprise two electrical contacts to receive the data from fuel cell system 200 and two separate electrical contacts to receive the power from fuel cell system 200. According to some embodiments, system 100 receives a single signal that transmits both the data and the power using currently-or hereafter-known power line data transmission techniques.

The data received from fuel cell system 200 may indicate a presence of fuel cell system 200. Such a feature may allow fuel cell system 200 to provide a smaller initial voltage to mobile computing system 100 than is otherwise required by some mobile computing systems. Specifically, a conventional mobile computing system may include a connector for receiving power from an external AC/DC adapter. The computing system holds the connector at a threshold voltage (e.g., 15VDC) that is lower than a supply voltage produced by a compatible external AC/DC adapter (e.g., 19VDC). The computing system therefore determines that an external AC/DC adapter is connected to the connector if it detects a voltage on the connector that is greater than the threshold voltage.

According to some embodiments, system management controller 170 transmits data to fuel cell system 200. The data may indicate an amount of power that mobile computing system 100 desires from fuel cell system 200. The data may be transmitted after controller 170 receives data from fuel cell system 200 indicating the presence of fuel cell system 200.

System management controller 170 may also determine whether the desired amount of power is available, and, if not, instruct system charger VR 130 to provide battery power from battery packs 110 and/or 120 for consumption by DC/DC converters and system loads 160. If the desired amount of power is available from fuel cell system 200, system management controller 170 may instruct system charger VR 130 to provide power from fuel cell system 200 for consumption by DC/DC converters and system loads 160. The above features may prove advantageous during start-up of mobile computing system 100, as some implementations of fuel cell system 200 may require extended periods of time to generate the desired amount of power. The above features may also or alternatively be advantageous during periods of heavy or prolonged power consumption by mobile computing system 100.

According to some embodiments, system management controller 170 determines whether system 100 is to simultaneously consume battery power and power provided by fuel cell system 200, and to instruct system charger VR 130 to selectively enable such consumption if desired. In some embodiments, the data received from fuel cell system 200 may indicate any number of parameters related to fuel cell system 200, including but not limited to fuel remaining, operational time remaining, fuel cell system temperature, and power dissipation rate. System management controller 170 may control operation of the elements of system 100 based on this indicated information. In one example, system management controller 170 may control these elements to operate in a low power consumption mode if the received data indicates that a fuel reservoir of fuel cell system 200 is almost depleted.

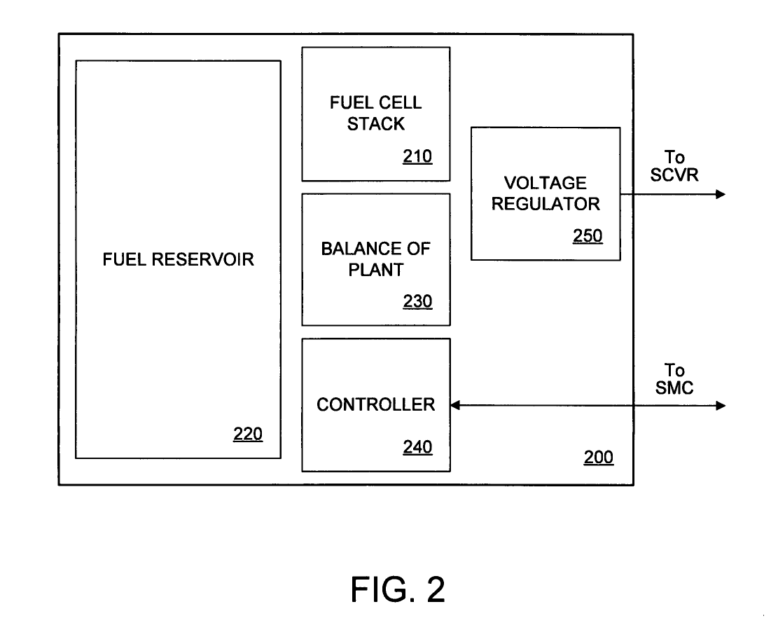

FIG. 2 is a block diagram of fuel cell system 200 according to some embodiments. Fuel cell system 200 may transmit data and generated power to mobile computing system 100. Some elements of fuel cell system 200 may comprise any currently- or hereafter-known system for converting chemical energy of a replenishable fuel source to electrical energy and for providing the electrical energy to a load.

Fuel cell system 200 according to the illustrated embodiment comprises fuel cell stack 210, fuel reservoir 220, “balance of plant” 230, controller 240 and voltage regulator 250. Each of elements 210 through 250 may be in communication with one or more of elements 210 through 250.

Fuel cell stack 210 may comprise one or more fuel cells. According to some embodiments, fuel cell stack 210 comprises fifteen fuel cells connected in series to generate a voltage roughly equal to fifteen times the voltage generated by a single fuel cell. In some embodiments, each fuel cell generates electrical energy by stripping electrons from hydrogen, transmitting the electrons to an electrical circuit through an anode, transmitting the stripped hydrogen ions (H⁺) to a cathode through a proton exchange membrane, receiving the electrons at the cathode, and recombining the received electrons with the stripped hydrogen ions (H⁺) and with oxygen to produce water as exhaust. Many alternative implementations of the above process currently exist and will be created in the future. Elements of fuel cell stack 210 may vary across the alternative implementations, including but not limited to anode material, cathode material, catalyst used for the stripping and recombining procedures, and proton exchange membrane structure and composition.

Fuel reservoir 220 may comprise any currently- or hereafter-known fuel cell fuel reservoir. Fuel reservoir 220 stores fuel from which the hydrogen used to power fuel cell stack 210 is derived. Fuel reservoir 220 may be removable and replaced with a similar fuel reservoir once the fuel of fuel reservoir 220 is exhausted. In some embodiments, fuel reservoir 220 is refillable so the physical structure of fuel reservoir 220 need not be removed in order to replenish fuel cell system 200.

Fuel reservoir 220 may store pure hydrogen, methanol, reformed methanol, ethanol, and/or any other currently- or hereafter-known fuel suitable for fuel cells. Fuel reservoir 220 may include elements for extracting hydrogen from the stored fuel and/or for monitoring an amount of fuel stored in fuel reservoir 220.

Balance of plant 230 may comprise elements used to facilitate the fuel cell process. Depending on the particular implementation of fuel cell system 200, such elements may comprise one or more of sensors, pumps, compressors, control valves, heat exchangers, hoses, blowers, control systems, a power conditioner, a fuel reformer, an inverter, and other elements.

Controller 240 provides electronic monitoring and control over one or more other elements of fuel cell system 200. Controller 240 may comprise one or more integrated circuits, which may be preprogrammed and/or capable of executing program code received from an external source and/or an internal memory. Controller 240 may transmit data to and receive data from system management controller 170 according to some embodiments. The transmitted data may indicate a presence of fuel cell system 200 and the received data may indicate an amount of power that mobile computing system 100 desires from fuel cell system 200.

Voltage regulator 250 may provide power to system charger VR 130. Voltage regulator 250 may regulate the power based on varying loads and/or instructions received by controller 240 from system management controller 170. According to some embodiments, voltage regulator 250 receives electrical energy from balance of plant 230 and provides output power based on signals received from controller 240.

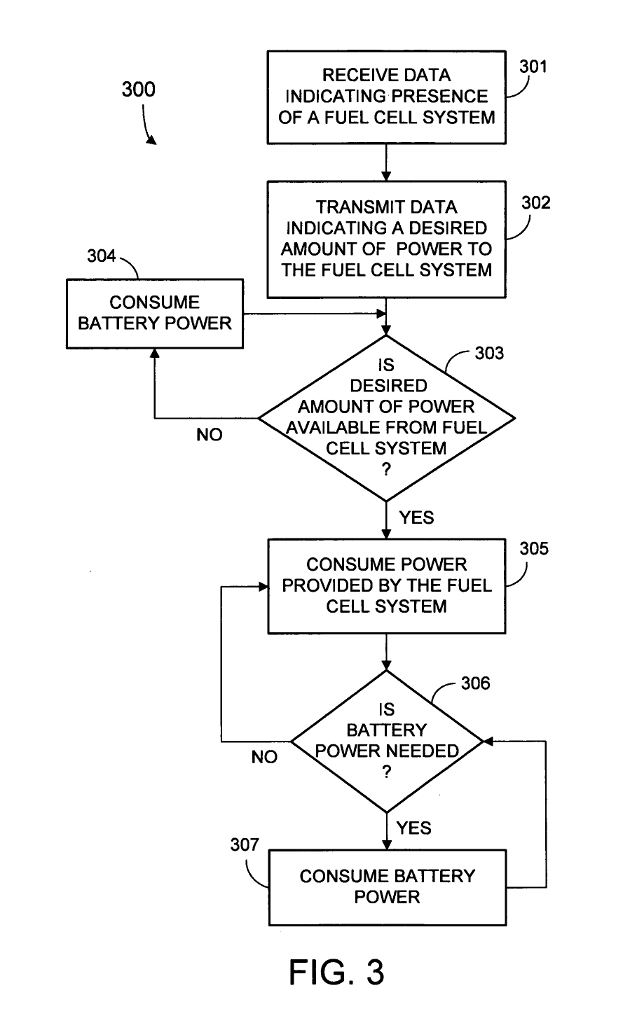

FIG. 3 is a flow diagram of process 300. Process 300 illustrates procedures executed by mobile computing system 100 to utilize power from fuel cell system 200 according to some embodiments. Process 300 may be executed by any combination of discrete components, integrated circuits, and/or software.

Initially, at 301, data is received indicating the presence of a fuel cell system. According to the present example, system management controller 170 receives the data from controller 240 of fuel cell system 200. The data may comprise any data capable of indicating a presence of fuel cell system 200 to system management controller 170. In some embodiments, the received data indicates a power rating and/or type of fuel cell system 200.

Data indicating a desired amount of power is then transmitted to the fuel cell system at 302. System management controller 170 may transmit this data to controller 240 of fuel cell system 200. Controller 240 may, in response, control the elements of fuel cell system 200 to generate the desired power and provide the desired power to system charger VR 130. Voltage regulator 250 may generate the power at a voltage indicated by the received data and may transmit the generated power to system charger VR 130. According to some embodiments, fuel cell system 200 might require substantial start-up time to generate and provide the desired power in a timely fashion.

At 303, it may therefore be determined whether the desired amount of power is available from the fuel cell system. System management controller 170 may make this determination by receiving an indication of the received power from system charger VR 130. If the desired amount of power is not available from the fuel cell system, battery power may be consumed at 304. According to some embodiments of 304, system management controller 170 instructs system charger VR 130 to provide battery power from battery packs 110 and/or 120 for consumption by DC/DC converters and system loads 160. If the desired amount of power is available from fuel cell system 200, system management controller 170 may instruct system charger VR 130 to provide power from fuel cell system 200 for consumption by DC/DC converters and system loads 160.

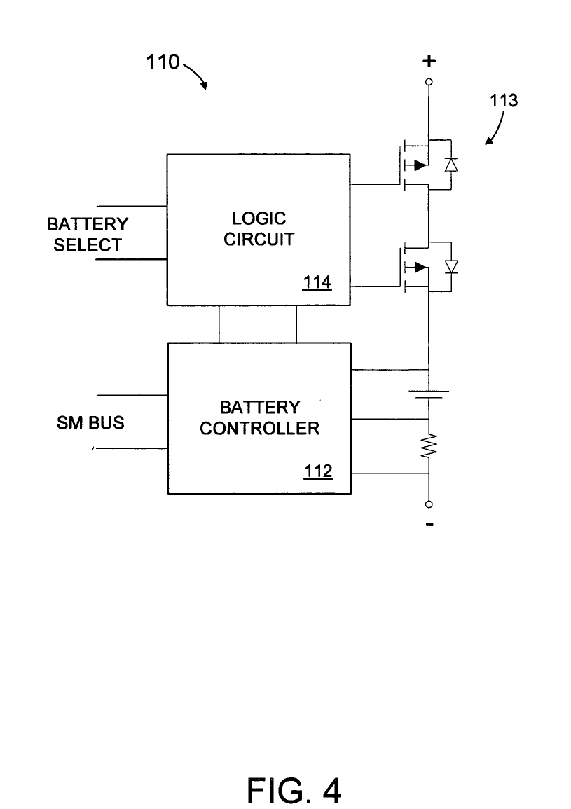

FIG. 4 is a schematic and block diagram of battery pack 110 according to some embodiments. The arrangement of FIG. 4 is described in the NVDC EBL specification, and other arrangements may be used in conjunction with some embodiments. The elements of FIG. 4 may allow mobile computing system 100 to selectively consume power from any one or more of fuel cell system 200, battery pack 110 and battery pack 120.

More particularly, battery controller 112 may operate similarly to a conventional battery controller. However, signals typically sent from battery controller 112 to MOSFETs 113 are initially received by logic circuit 114. Logic circuit 114 also receives a Battery Select signal from system charger VR 130. As described in the NVDC EBL specification, the Battery Select signal may be enabled when “low”, de-selected by default, and comprised of 3.3V control signals. Logic circuit 114 controls MOSFETs 113 so that power from battery pack 110 is selectively consumed based on the received signals. Battery pack 120 may also be implemented as shown in FIG. 4.

Returning to process 300, flow cycles between 304 and 303 until the determination at 303 is positive. Flow then proceeds to 305 to consume power provided by the fuel cell system. In order for mobile computing system 100 to consume power provided by fuel cell system 200 at 305, system management controller 170 may instruct system charger VR 130 to deliver power received from fuel cell system 200 to DC/DC converters and system loads 160.

At 306, it is determined whether battery power is needed. System management controller 170 may continuously monitor power consumption of mobile computing system 100 and determine at 306 that battery power is desired. According to some embodiments of 306, a user of mobile computing system 100 launches a display-intensive application that requires a significant amount of power and system management controller 170 receives an indication that system 100 is about to enter a high power consumption mode. In some embodiments, system management controller 170 may alternatively determine at 306 that system 100 is to simultaneously consume battery power and power provided by fuel cell system 200.

Battery power (and, in some embodiments, power from the fuel cell system) is consumed at 307 if it is determined at 306 that battery power (and power from the fuel cell system) is needed. Mobile computing system 100 may operate to consume battery power at 307 as described with respect to 304. If battery power is not needed, flow returns to 305 from 306 and continues as described above. Flow may therefore cycle between 305, 306 and 307 until fuel cell system 200 is disconnected or depleted, battery packs 110 and 120 are disconnected or depleted, or until mobile computing system 100 is powered off.

In some embodiments, operating data is received from fuel cell system 200 during process 300 that indicates fuel remaining, operational time remaining, fuel cell system temperature, and/or power dissipation rate. The operating data may be received periodically and/or in response to a change in the operating data according to some embodiments. System management controller 170 may base the determination at 306 on the operating data. System management controller 170 may also or alternatively change a power consumption mode of system 100 based on the operating data.

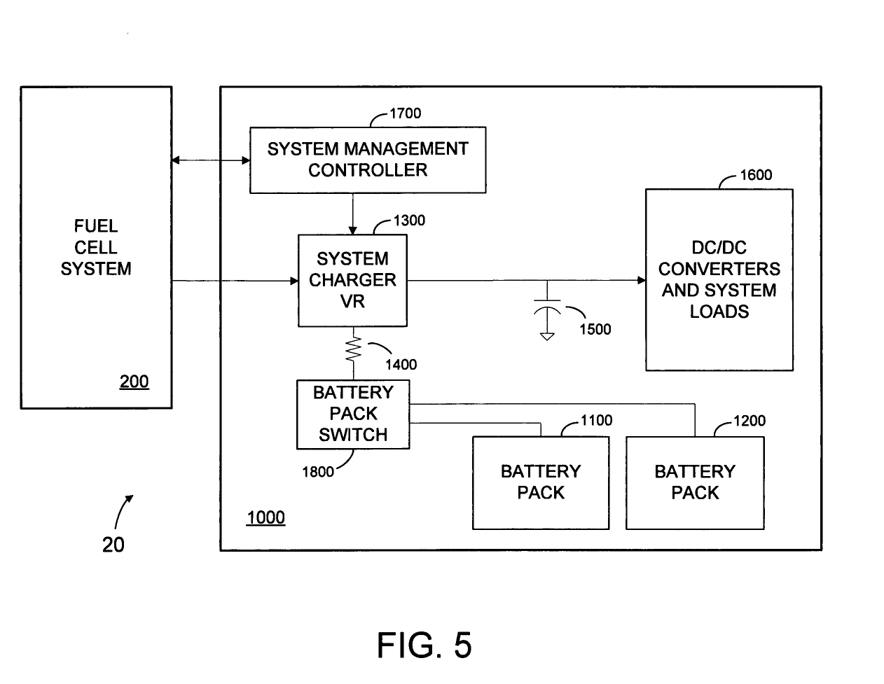

FIG. 5 is a block diagram of system 20 according to some embodiments. System 20 comprises fuel cell system 200 as described above and mobile computing device 1000. System 20 may be used to execute process 300. Except as noted below, the components of mobile computing device 1000 may be implemented and may function similarly to the identically-named components of mobile computing device 100 of FIG. 1.

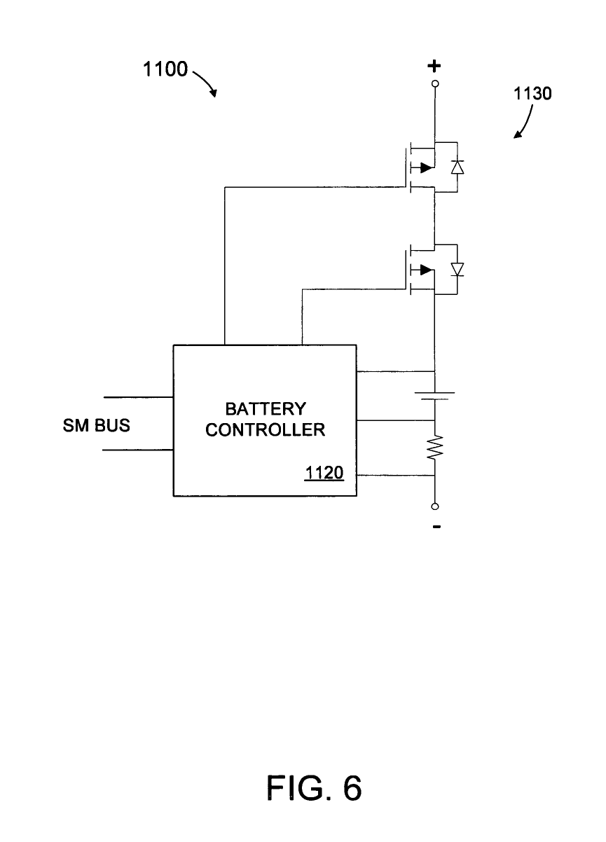

Mobile computing device 1000 includes battery pack switch 1800. Battery pack switch 1800 may receive a signal from system charger VR 1300 and may select one or both of battery packs 1100 and 1200 based on the signal. Battery pack switch 1800 may be used in some embodiments in which battery packs 1100 and 1200 do not include elements allowing their direct selection by system charger VR 1300. Implementations of battery pack switch 1800 and battery packs 1100 and 1200 are known to those in the art. FIG. 6 is a schematic and block diagram of a conventional implementation of battery pack 1100.

Battery pack 1100 of FIG. 6 includes battery controller 1120 and MOSFETs 1130. As shown, battery controller 1120 delivers control signals to MOSFETs 1130 to control power provided by battery pack 1100. Battery pack 1100 does not provide a Battery Select input as shown in FIG. 4, therefore battery pack switch 1800 may be used (e.g. at 304 and 307 of process 300) to selectively couple battery pack 1100 to system charger VR 1300. Battery pack 1200 may be implemented similarly to battery pack 1100 of FIG. 6.

The several embodiments described herein are solely for the purpose of illustration. Some embodiments may include any currently or hereafter-known versions of the elements described herein. Therefore, persons skilled in the art will recognize from this description that other embodiments may be practiced with various modifications and alterations.

1. An apparatus comprising:
a fuel cell system to transmit first data to a mobile computing system, to generate power, and to deliver the generated power to the mobile computing system.

2. An apparatus according to claim 1,
the fuel cell system comprising two electrical contacts to transmit the first data to the mobile computing system and to deliver the generated power to the mobile computing system.

3. An apparatus according to claim 1,
the fuel cell system comprising:
a first pair of electrical contacts to transmit the first data to the mobile computing system; and
a second pair of electrical contacts to deliver the generated power to the mobile computing system.

4. An apparatus according to claim 3, wherein the first pair of electrical contacts is to receive second data from the mobile computing system.

5. An apparatus according to claim 1, wherein the fuel cell system is to receive second data from the mobile computing system, and wherein the generated power is delivered to the mobile computing system based on the second data.

6. An apparatus according to claim 1, wherein the first data indicates a power rating of the fuel cell system.

7. An apparatus comprising:
a mobile computing system to receive power from a fuel cell system and to receive first data from the fuel cell system.

8. An apparatus according to claim 7,
the mobile computing system comprising two electrical contacts to receive the first data from the fuel cell system and to receive the power from the fuel cell system.

9. An apparatus according to claim 7,
the mobile computing system comprising:
a first pair of electrical contacts to receive the first data from the fuel cell system; and
a second pair of electrical contacts to receive the power from the fuel cell system.

10. An apparatus according to claim 7, wherein the mobile computing system is to transmit second data to the fuel cell system, and wherein the power is received from the mobile computing system based on the second data.

11. An apparatus according to claim 7, wherein the first data indicates a power rating of the fuel cell system.

12. An apparatus according to claim 7, further comprising:
a battery to provide battery power to the mobile computing system, wherein the mobile computing system is to selectively consume the power received from the fuel cell system, the battery power, or both the battery power and the power received from the fuel cell system.

13. A system comprising:
a fuel cell system to transmit first data, to generate power, and to deliver the generated power; and
a mobile computing system to receive the first data, and to receive the generated power.

14. A system according to claim 13,
the mobile computing system comprising two electrical contacts to receive the first data from the fuel cell system and to receive the power from the fuel cell system.

15. A system according to claim 13,
the mobile computing system comprising:
a first pair of electrical contacts to receive the data from the fuel cell system; and
a second pair of electrical contacts to receive the power from the fuel cell system.

16. A system according to claim 13,
the fuel cell system comprising two electrical contacts to transmit the first data to the mobile computing system and to deliver the generated power to the mobile computing system.

17. A system according to claim 13,
the fuel cell system comprising:
a first pair of electrical contacts to transmit the first data to the mobile computing system; and
a second pair of electrical contacts to deliver the generated power to the mobile computing system.

18. A system according to claim 13, the mobile computing system to transmit second data to the fuel cell system, the fuel cell system to generate the power based on the second data, and the fuel cell system to deliver the generated power based on the second data.

19. A system according to claim 13, wherein the first data indicates a power rating of the fuel cell system.

20. A system according to claim 13, further comprising:
a battery to provide battery power to the mobile computing system, wherein the mobile computing system comprises a device to select consumption of either the power received from the fuel cell system, the battery power, or both the battery power and the power received from the fuel cell system.

21. A method comprising:
receiving first data indicating the presence of a fuel cell system; and
transmitting second data to the fuel cell system, the second data indicating an amount of power desired from the fuel cell system.

22. A method according to claim 21, further comprising:
determining whether the desired amount of power is available from the fuel cell system;
if the desired amount of power is not available, consuming battery power provided by a battery; and
if the desired amount of power is available, consuming power provided by the fuel cell system.

23. A method according to claim 21, further comprising:
determining whether to simultaneously consume battery power provided by a battery and power provided by the fuel cell system; and
consuming the battery power and the power provided by the fuel cell system.

24. A method according to claim 21, further comprising:
selectively consuming battery power provided by a battery and power provided by the fuel cell system.

25. A method according to claim 21, further comprising:
receiving operating data from the fuel cell system indicating one or more of fuel remaining, operational time remaining, fuel cell system temperature, and power dissipation rate.

26. A method according to claim 25, further comprising:
changing a power consumption mode based on the operating data.

27. A system comprising:
a fuel cell system to transmit first data, to generate power, and to deliver the generated power;
a mobile computing system to receive the first data, and to receive the generated power; and
a Li-Ion battery to provide battery power to the mobile computing system.

28. A system according to claim 27, wherein the mobile computing system comprises a device to select consumption of either the power received from the fuel cell system, the battery power, or both the battery power and the power received from the fuel cell system.

29. A system according to claim 27,
the mobile computing system comprising two electrical contacts to receive the first data from the fuel cell system and to receive the power from the fuel cell system.

30. A system according to claim 27,
the mobile computing system comprising:
a first pair of electrical contacts to receive the data from the fuel cell system; and
a second pair of electrical contacts to receive the power from the fuel cell system.
